(19) United States
(12) Patent Application Publication
(10) Pub. No.: US 2026/0124816 A1
(43) Pub. Date: May 7, 2026

(54) METHOD FOR CHECKING A PROCESS FOR BUILDING A TYRE AND SYSTEM FOR CHECK THEREOF

(71) Applicant: PIRELLI TYRE S.P.A., Milano (IT)

(72) Inventors: Fabio REGOLI, Milano (IT); Daniele PECORARO, Milano (IT); Stefano MARTINA, Milano (IT)

(21) Appl. No.: 19/128,955

(22) PCT Filed: Dec. 12, 2023
(86) PCT No.: PCT/IT2023/050278

§ 371 Date: May 9, 2025

(30) Foreign Application Priority Data
Dec. 19, 2022 (IT) 102022000025944

(51) Int. Cl. B29D 30/30; B29D 30/08

(52) U.S. Cl. CPC B29D 30/30; B29D 2030/082

(57) ABSTRACT

A method and system for checking a process for building a tyre including sequential deposition of an ordered plurality of N semi-finished elements on a drum. The method includes: establishing an ordered plurality of N classes of drum states, wherein a first class corresponds to a bare drum state and an i-th class corresponds to a drum state including the i-1th semi-finished element deposited in radially outermost position; before the deposition of the i-th semi-finished element: processing an acquired image of a drum state to associate to the current drum state a current class among the ordered plurality of N classes of drum states; authorising the deposition of the i-th semi-finished element based on a comparison between the current class and the expected class.

### TECHNICAL FIELD OF THE INVENTION

The present invention concerns a method for checking a process for building a tyre, a relative system for checking and a relative process and plant for building a tyre.

### PRIOR ART

In the context of the industrial production of tyres, processes for building green (i.e. unvulcanised) tyres are known in which an ordered plurality of semi-finished elements is deposited in sequence on a building drum, rotatable around an axis. Typically, these depositions are carried out automatically by a machine.

WO2012001562A1 describes a method for checking the deposition of semi-finished elements for the production of tyres.

DE 102019211023A1 describes a method for measuring a junction that is open or overlapping of a layer of material during the production of green tyres.

### DEFINITIONS

The terms “radial” and “axial” and the expressions “radially internal/external” and “axially internal/external” are used with reference to the radial direction and to the axial direction of the tyre that is being processed/green/moulded and vulcanised or of the building drum, hereinafter more simply “drum”, i.e. to a direction perpendicular to the axis of rotation of the aforementioned tyre/drum and to a direction parallel to the axis of rotation thereof, respectively.

The terms “circumferential” and “circumferentially” are instead used with reference to the annular development of the tyre or said drum.

By “drum state”, or similar expressions, it is intended to mean the assembly comprising the drum as such and all the elements possibly deposited on the drum. “Bare drum state” means a drum state consisting of the drum alone as such, without any element deposited on the drum.

“Class of drum states” means the set of all possible drum states homogeneous with each other in relation to the presence of semi-finished elements.

“Semi-finished element” means any element that is incorporated into the green tyre during the building step on the drum and that acts as a precursor of all or part of a component of the finished tyre. One or more of (in one embodiment all) such semi-finished elements may wrap around the entire circumferential development of the drum. One or more of the (in one embodiment all) semi-finished elements may be radially superimposed on each other, for example each element is deposited on top of the previously deposited element. One or more of the semi-finished elements may comprise, or consist entirely of, elastomeric compound, typically unvulcanised.

“Component of the tyre” means any component, or a portion thereof, adapted to perform a function in the tyre, for example, components such as the liner, the underliner, the complex, the carcass ply(s), the underbelt inserts, the belt layers both crossed one another and at zero degrees, the tread band underlayer, the tread band, the bead core, the bead fillers, the textile reinforcement inserts, either metallic or elastomeric material only, the anti-abrasive inserts, the sidewall inserts.

“Two-dimensional image”, or “2D image”, of a surface means a digital image to each pixel of which there is associated a piece of information representative of the reflectivity/diffusivity and/or colour of the surface, such as the images detected by the common digital cameras (e.g. CCD). In other words, the 2D image represents the visual appearance of the surface.

“Matrix image” means a digital image whose pixels form a rectangular matrix having the two dimensions of comparable length (for example, the two dimensions differ by less than an order of magnitude, as in 4×3 or 3×2 formats).

### SUMMARY OF THE INVENTION

As part of the process for building a tyre, the Applicant has observed that it is necessary for the semi-finished elements to be deposited correctly and/or in the correct sequence. According to the Applicant, the method for checking the deposition of semi-finished products based on the detection, directly or indirectly, of the thickness and/or of height profile of the radially external layer of the drum state, as for example described in WO2012001562A1 and DE102019211023A1, may in certain circumstances be unreliable (for example in the case of semi-finished elements that are very thin and/or with complex patterns, as in the case of bicycle tyres), and/or entail high costs for example due to the protection systems necessary for the personnel involved due to the use of laser radiations, and/or execution times not compatible with current industrial needs.

The Applicant therefore dealt with the problem of checking the correct deposition of semi-finished elements in an automatic, reliable, fast manner, and/or at low cost.

The Applicant has found that the use of predetermined classes of the drum state, where the current drum state is classified into one of these classes by processing an image acquired before the deposition of a semi-finished element, and where said current class is compared with the class previous to the one corresponding to the deposition of said semi-finished element, allows the aforementioned problem to be solved.

In one aspect the invention concerns a method for checking a process for building a tyre, the building process comprising the sequential deposition of an ordered plurality of N semi-finished elements on a drum.

The method preferably comprises:
predetermining an ordered plurality of N classes of drum states, wherein a first class corresponds to a bare drum state and an i-th class, with i ranging from 2 to N, corresponds to a drum state including the i-1th semi-finished element deposited in radially outermost position.

The method preferably comprises, before the deposition of an i-th semi-finished element:
acquiring at least one image of a current drum state;
processing said at least one image to associate to said current drum state a current class among said ordered plurality of N classes of drum states;
authorising the deposition of said i-th semi-finished element on the basis of a comparison between said current class and an expected class, said expected class being the i-th class in said ordered plurality of classes.

In one aspect the invention concerns a process for building a tyre, the process comprising: depositing in sequence an ordered plurality of N semi-finished elements on a drum, wherein it is envisaged to check said process by said method for checking.

In one aspect the invention concerns a system for checking a machine for building a tyre, the machine being structured to deposit in sequence an ordered plurality of N semi-finished elements on a drum.

Preferably the system for checking comprises:
an image acquisition system; and
a command and control unit programmed and configured for, before the deposition of an i-th semi-finished element:
   acquiring from said image acquisition device at least one image of a current drum state;
   processing said at least one image to associate to said current drum state a current class among an ordered plurality of N classes of drum states, wherein a first class corresponds to a bare drum state and an i-th class, with i ranging from 2 to N, corresponds to a drum state comprising the i-1th semi-finished element deposited in radially outermost position;
   authorising the deposition of said i-th semi-finished element on the basis of a comparison between said current class and an expected class, said expected class being the i-th class in said ordered plurality of classes.

In one aspect the invention concerns a plant for building a tyre comprising:
a machine for building a tyre structured to deposit in sequence an ordered plurality of N semi-finished elements on a drum and
said system for checking.

The Applicant considers that the aforementioned characteristics, in particular the processing of an (digital) image of the drum state, preferably of at least a portion of a radially outermost surface of the drum state, acquired before the deposition of an i-th semi-finished element to associate to the current drum state a current class among an ordered plurality of N predetermined classes of drum states, and authorising the deposition of the i-th semi-finished element on the basis of a comparison between said current class and the expected class, causes the i-th semi-finished element to be deposited only in the presence of the i-1-th semi-finished element correctly deposited on the drum state. This expected class is the i-th class in said ordered plurality of classes, i.e. the class preceding the class corresponding to a drum state with said i-th semi-finished element last deposited.

The Applicant considers that the operating logic based on the predetermined classes of drum states allows to obtain a high reliability and correctness of evaluation, compared to the known deposition check logics based on the measurement, direct or indirect, for example by means of physical probes, laser triangulation or laser telemetry, of the altimetric profile and/or the thickness of the radially external surface of the drum state. In fact, according to the Applicant, the methods based on the thickness or altimetric profile may require a calibration on the basis of the diameter of the drum, or may be distorted by localized anomalies (for example at joints, overlaps, etc.) or by very thin thicknesses or may still require measurement at many points along the circumferential development such as for example in the case of components that do not overlap along the entire circumferential development to the previously built component (for example for the chafers), finally other anomalies of the aforementioned methods may result from axially variable thicknesses.

The Applicant has also verified that the classification of the drum state in the current class through image processing and its comparison with the expected class is fast (also because only one image may be sufficient) and/or with low demand in terms of computational resources and complexity and/or cost of the method and system.

According to the Applicant, the method and the system of the present invention are also suitable, due to the low invasiveness in terms of hardware and operation, to be implemented also in pre-existing building machines. More specifically, this low invasiveness is also the result of the preferred use as radiation for the acquisition of light images in the visible field, which does not require any type of additional protection for the personnel in charge.

The present invention may have one or more of the following preferred features.

In one embodiment, said acquiring, processing and authorising are performed before the deposition of each i-th element of said ordered plurality of N elements. In this way, the entire deposition process, element by element, is subjected to an automatic check (independently of any downtime of machine), for example in order to automatically manage situations in which a semi-finished element has not automatically attached to the drum and has slipped on the ground or has not been correctly positioned on the deposition feed stand.

In one embodiment, said acquiring, processing and authorising are carried out under the condition of a (more preferably of each) restart from a downtime of machine (i.e. any interruption of the normal automatic deposition cycle of the semi-finished elements). In other words, the method for checking is performed before the deposition of an i-th element, provided that such deposition must take place after a downtime of machine. The Applicant has in fact verified that often the defects of deposition of elements are correlated to downtime of machine that occurred immediately before the defective deposition. For example, in the event that an operator, after stopping the machine, proceeds to manually remove the last semi-finished element deposited, or to manually apply a semi-finished element, the present invention ensures that on the next restart the machine deposits the correct semi-finished element of the envisaged sequence.

Preferably, provided that said current class is equal to said expected class, it is provided to authorise said deposition of said i-th semi-finished element. In the event of a current state (i.e. the actual drum state at the time of the comparison) conforming to the expected state (i.e. the drum state correlated to the point of the deposition process in which the machine is located, also called ‘machine state’), the process is allowed to continue.

Preferably, provided that said current class is different from said expected class, it is envisaged not to authorise said deposition of said i-th semi-finished element (for example by interrupting the building process). More preferably it is envisaged to generate an alarm signal.

Preferably said predetermining comprises, for each class, acquiring a respective set (for example in a number greater than or equal to one thousand) of images of drum states belonging to said class, and associating said respective together with said class. This predetermination takes advantage of the fact that the images acquired are related to situations of normal building process, and therefore these images are easy and quick to find.

Preferably said processing comprises processing a visual appearance of a radially external surface of the current drum state, for example of the bare drum or of a semi-finished element in radially outermost position. More preferably said processing comprises processing a visual appearance of a surface structure, or “texture”, of a radially external surface of the current drum state. The Applicant has observed that the classification by processing the visual appearance of the structure, or texture, surface of the visible surface of the drum state is fast, reliable and/or requires low computational resources. Furthermore, this processing does not pose particular problems of positioning the telecamera and/or of geometric synchronization with the drum.

Preferably it is provided to compare said at least one image with each set of images, said current class being more preferably associated as a function of a comparison between a visual appearance of a radially external surface, or of a surface structure of a radially external surface, of the current drum state in said at least one image and a respective visual appearance of a radially external surface, or of a respective surface structure of a radially external surface, of the drum state in each set of images.

Preferably said current class is the class corresponding to the set of images having overall the visual appearance of the respective surface structure most similar to the visual appearance of the surface structure of the radially external surface of the current drum state in said at least one image. In other words, processing can mimic the functioning of the human brain, which classifies the displayed element (bare drum or the radially outermost element) by comparing the appearance of the surface structure with a memory of the different possible surface structures.

Preferably said at least one image and/or each of said images is a two-dimensional, or 2D, image.

Preferably said at least one image and/or each of said images is a matrix image.

Preferably said at least one image and/or each of said images is acquired at least in a visible spectrum.

In one embodiment, the semi-finished elements are selected in the group: underbelt inserts, first belt layer, second belt layer, zero-degree belt layer, tread band underlayer, tread band, sidewalls or a portion thereof.

In one embodiment, the semi-finished elements are selected in the group: liner, underliner, complex, first carcass ply, second carcass ply, sidewall inserts, sidewalls or a portion thereof, underbelt inserts, anti-abrasive inserts, circumferential reinforcing elements.

Preferably, each semi-finished element is a strip of material, e.g. having a length equal to or (slightly) greater than a circumferential development of the drum state before the deposition of said semi-finished element, or is obtained by spirally winding a continuous long-shaped element over the drum state.

Preferably the system for checking comprises a lighting system structured to illuminate at least in part said drum state.

### BRIEF DESCRIPTION OF THE FIGURES

FIG. 1 shows, in front view, schematically and partially a plant for building a tyre comprising a system for checking according to the present invention;

FIG. 2 schematically shows a flowchart of a method for checking according to the present invention.

### DETAILED DESCRIPTION OF PREFERRED EMBODIMENTS OF THE INVENTION

The features and advantages of the present invention will be further clarified from the following detailed description of some embodiments, presented by way of non-limiting example of the present invention, with reference to the attached figures.

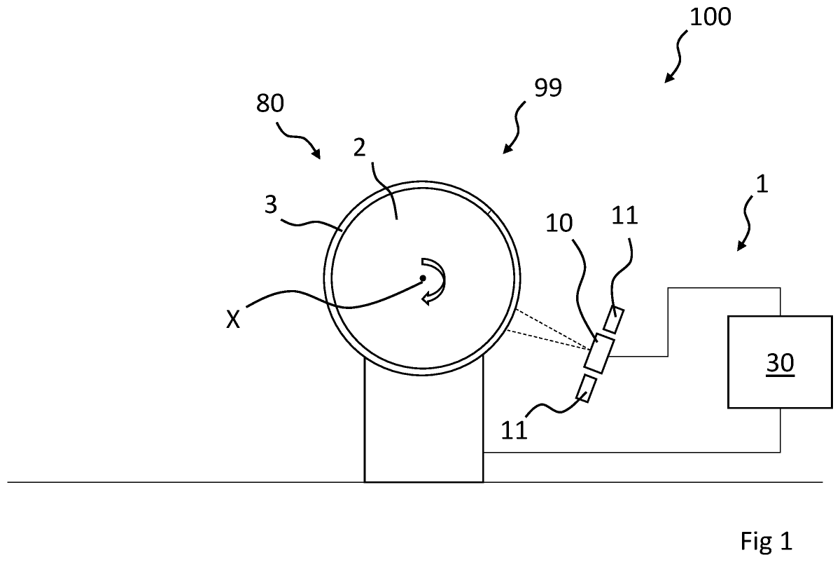

FIG. 1 with the number 100 globally indicates a plant for building a tyre.

The plant 100 comprises a machine for building a tyre 99. The machine 99 comprises a drum 2 rotatable about an axis of rotation X (perpendicular to the plane of the figure) and is structured to deposit in sequence an ordered plurality of N semi-finished elements on the drum 2, with N greater than or equal to two (and typically less than ten). Depending on the type of process used, the drum 2 can have a substantially toroidal or substantially cylindrical shape.

The machine for building a tyre 99 and its relative operation are not further described and illustrated as for example of known type.

The plant 100 further comprises a system for checking 1 the building machine 99.

Preferably the system for checking 1 comprises an image acquisition device 10 structured to acquire images of the current drum state 80. Exemplarily, each acquired image represents a portion (e.g. having an angle subtended in the centre greater than 30°, e.g. about 90°) of a radially outermost surface of the current drum state 80. In the figure, a drum state 80 consisting of the drum 2 and of a first semi-finished element 3 last deposited directly on the bare drum 2 is exemplarily shown. Exemplarily, the device 10 comprises a tele-, or video-, 2D matrix digital camera (for example of known type), i.e. adapted to capture two-dimensional matrix digital images, typically in the visible. Preferably, the system for checking 1 comprises a lighting system 11 structured to illuminate at least in part said drum state (for example two white light LED lamps arranged on opposite sides of the device 10).

Preferably the system for checking 1 comprises a command and control unit 30 operatively connected to said acquisition device 10 and more preferably to said building machine 99. Preferably the command and control unit 30 is configured and programmed to command and check the entire operational functioning of the machine 99, for example in a manner known per se.

In FIG. 1 the command and control unit 30 is schematically depicted as a single unit. However, the command and control unit 30 can be realized with any architecture of suitable hardware and/or software modules. For example, the command and control unit 30 can be realized by a plurality of hardware and software modules logically and/or physically distinct and separate from each other and interoperating with each other. For example, the command and control unit 30, in particular its portion that performs the functions of acquiring and processing the images, may be, in whole or in part, logically and physically integrated into the acquisition device 10.

The system for checking 1 and the plant 100, in use, are adapted to implement respectively the method for checking and the relative process for building a tyre of the present invention.

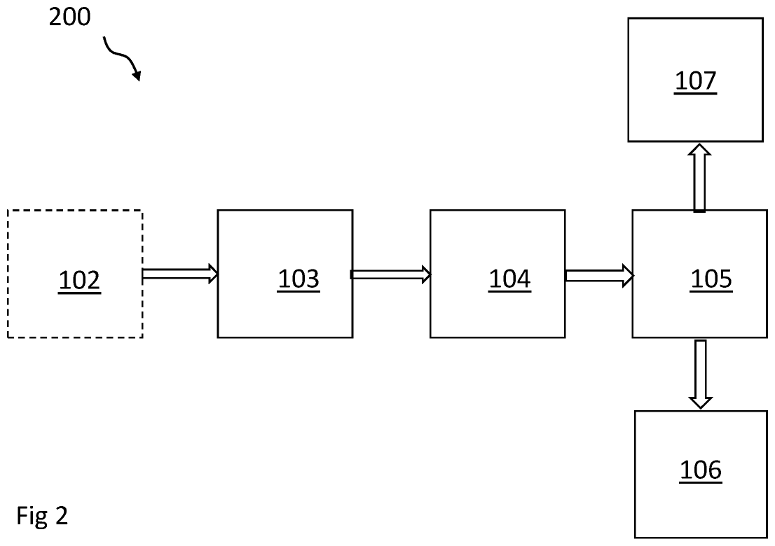

FIG. 2 schematically shows a flowchart of an example method for checking 200 according to the present invention.

For purely exemplary purposes, the second step of a two-step building process will be considered. In a first step (not shown as it is known per se), the radially innermost structure of the tyre is built on a drum, i.e. the carcass sleeve comprising for example the liner, the underliner (alternatively the so-called complex which generally comprises liner, underliner and anti-abrasive inserts), the carcass ply(s), the beads associated with its filler insert, possibly the sidewalls or a part of them and any other components such as the underbelt inserts, the anti-abrasive inserts, the sidewall inserts and any other circumferential reinforcing elements. In the second step, the radially outermost structure of the tyre is built on a respective drum, the so-called crown sleeve comprising for example a first belt layer, a second belt layer, a zero-degree belt layer, a tread band underlayer, the tread band and possibly the underbelt inserts, the sidewalls or a portion thereof. The two structures are then coupled in a forming station, not shown as known per se, using the drum of the first step or a further forming drum. However, the present invention is applicable to any building process, including the process in which the various components of the tyre are made on the same drum.

In the example considered, the building process of the second step provides for the sequential deposition on the drum of an ordered plurality of four semi-finished elements. The ordered sequence of the semi-finished elements is as follows: first belt layer, second belt layer, zero-degree belt layer, tread band. Exemplarily, the first two semi-finished elements consist of a respective strip of elastomeric material reinforced by textile, metallic or hybrid cords, parallel to each other, for example having a length equal to or (slightly) greater than a circumferential development of the drum state before deposition. The zero-degree belt layer is exemplarily made by spirally winding over the drum state of a continuous longiform element, each turn being for example adjacent to the successive turn. The tread band may consist of a strip of elastomeric material, for example having a length equal to or (slightly) greater than a circumferential development of the drum state before deposition. Each semi-finished element covers the entire circumferential development of the previous drum state.

Preliminarily, it is envisaged to predetermine 102 an ordered plurality of four classes of drum states, wherein the first class corresponds to the bare drum state and the i-th class, with i ranging from 2 to 4, corresponds to a drum state including the i-1th semi-finished element deposited in radially outermost position (i.e. last deposited). In other words, the second class, i=2, corresponds to the drum state comprising the last deposited first semi-finished element (i.e. the first belt layer), the third class, i=3, corresponds to the drum state comprising the last deposited second semi-finished element (i.e. the second belt layer), and the fourth class, i=4, corresponds to the drum state comprising the last deposited third semi-finished element (i.e. the zero-degree belt layer).

For each class, said predetermining 102 comprises for example preliminarily acquiring a respective set (for example in a number greater than or equal to one thousand) of images of drum states belonging to said class, and associating said respective together with said class. Preferably the images thus acquired refer to conditions of normal operation of the process. In this way, four homogeneous sets of images are stored, wherein the images of each set are representative of portions of the external surface of the same respective drum state. The surface portions are acquired independently of the respective angular positions. For example, the first set contains about three thousand 2D images of portions of bare drum, the second set contains about three thousand 2D images of the drum with only the first belt layer deposited thereon, and so on.

Exemplarily, it is assumed that the first semi-finished element (i=1), i.e. the first belt layer, must be deposited. In this case, the current state of the drum, i.e. the actual state, under normal operating conditions is the bare drum state, belonging to the first predetermined class (i=1).

Before depositing the first carcass belt layer, it is envisaged to acquire 103, from said image acquisition device 10, at least one image of the current drum state.

In one embodiment, a single image of the current drum state is sufficient to implement the present method for checking. Such an image can also be advantageously acquired independently of the angular position of the drum and without particular problems of telecamera positioning precision. In other embodiments, for example in the case where the previously deposited semi-finished element does not cover the entire circumferential development of the drum, it is possible to acquire multiple images with the drum in different angular positions, for example four images at 90° to each other, and subject each acquired image to the same processing in order to introduce redundancy in the classification and/or to check the entire surface of the drum state.

It is therefore envisaged to process 104 the acquired image to associate to it, and therefore to the current drum state, a current class among the aforementioned ordered plurality of four classes of drum states. This current class represents the actual drum state.

Preferably such processing takes into consideration the visual appearance (rather than the altimetric profile) of the surface structure of the acquired radially external surface portion of the current drum state. Preferably a comparison is made between such visual appearance and the visual appearance of the respective surface structure of the radially external surface of the drum state in each set of images. Preferably the associated current class is the class corresponding to the set of images having the respective surface structure that is the most similar in appearance to the surface structure visible in the acquired image. To this end, suitable image recognition algorithms can be used, for example of a known type, which allow, for example, the training of a neural network (“machine learning”) through the aforementioned sets of images.

It is therefore envisaged to compare 105 the current class with the expected class, that is, in the aforementioned ordered plurality of predetermined classes, the first class. This expected class corresponds to the machine state, i.e. the drum state correlated to the point of the deposition process in which the machine is located (in the present case, the machine is located at the point of the deposition process that requires the bare drum state).

Preferably, provided that the current class is equal to the expected class, it is envisaged to authorise 106 the deposition of the first semi-finished element. In case of actual drum state conforming to the drum state required by the point of the deposition process in which the machine is located, the process is allowed to continue.

Preferably, provided that the current class is different from the expected class, it is envisaged not to authorise 107 the deposition of the first semi-finished element (for example by interrupting the building process), more preferably it is envisaged to generate an alarm signal. In this case, the operator can act on the machine interface to change the machine state to make it conform to the current state (this change can also be introduced automatically by the system for checking), and/or can manually intervene on the drum state to make it conform to the machine state.

The operations from 103 to 107 may be repeated with reference to the deposition of any other semi-finished element.

These operations can be performed before the deposition of each i-th semi-finished element, or only in the case of each restart from a downtime of machine.

1.-17. (canceled)

18. A method for checking a process for building a tyre, the process for building comprising the sequential deposition of an ordered plurality of N semi-finished elements on a drum, the method comprising:
establishing an ordered plurality of N classes of drum states, wherein a first class corresponds to a bare drum state and an i-th class, with i ranging from 2 to N, corresponds to a drum state including an i-1th semi-finished element deposited in radially outermost position; wherein the method comprises, before deposition of the i-th semi-finished element:
acquiring at least one image of a current drum state;
processing said at least one image to associate to said current drum state a current class among said ordered plurality of N classes of drum states;
authorising the deposition of said i-th semi-finished element on the basis of a comparison between said current class and an expected class, said expected class being the i-th class in said ordered plurality of classes.

19. The method according to claim 18, wherein said acquiring, processing and authorising are performed before the deposition of each i-th element of said ordered plurality of N elements.

20. The method according to claim 19, wherein said acquiring, processing and authorising are performed on condition of a restart from a downtime of machine.

21. The method according to claim 20, wherein, provided that said current class is equal to said expected class, the method further comprises authorising said deposition of said i-th semi-finished element.

22. The method according to claim 20, wherein, provided that said current class is different from said expected class, the method further comprises not authorising said deposition of said i-th semi-finished element.

23. The method according to claim 20, wherein said predetermining includes, for each class, acquiring a respective set of images of drum states belonging to said class, and associating said respective set with said class.

24. The method according to claim 23, where said processing comprises processing a visual appearance of a radially external surface of the current drum state.

25. The method according to claim 23, including comparing said at least one image with each set of images, said current class being associated as a function of a comparison between a visual appearance of a radially external surface of the current drum state in said at least one image and a respective visual appearance of a radially external surface of the drum state in each set of images.

26. The method according to claim 25, where said current class is the class corresponding to the set of images having overall the visual appearance of the respective surface structure most similar to the visual appearance of the surface structure of the radially external surface of the current drum state in said at least one image.

27. The method according to claim 26, wherein said at least one image is a two-dimensional and matrix image and said at least one image is acquired at least in a visible spectrum.

28. The method according to claim 27, wherein each semi-finished element is a strip of material having a length equal to or slightly greater than a circumferential development of the drum state prior to a deposition of said semi-finished element, or it is obtained by spiral winding of a continuous elongated element on the drum state.

29. The method according to claim 28, where semi-finished elements are selected from the group consisting of: underbelt inserts, first belt layer, second belt layer, zero-degree belt layer, tread band underlayer, tread band, sidewalls or a portion thereof.

30. The method according to claim 28, where semi-finished elements are selected from the group consisting of: liner, underliner, complex, first carcass ply, second carcass ply, sidewall inserts, sidewalls, underbelt inserts, anti-abrasive inserts, circumferential reinforcing elements.

31. A process for building a tyre, the process comprising: depositing in sequence an ordered plurality of N semi-finished elements on a drum, wherein said process comprises a checking method according to claim 28.

32. A system for checking a machine for building a tyre, the machine being structured to deposit in sequence an ordered plurality of N semi-finished elements on a drum, the system comprising:
an image acquisition device, and
a command and control unit programmed and configured for, before deposition of an i-th semi-finished element:
acquiring from said image acquisition device at least one image of a current drum state,
processing said at least one image to associate to said current drum state a current class among an ordered plurality of N classes of drum states, wherein a first class corresponds to a bare drum state and an i-th class, with i ranging from 2 to N, corresponds to a drum state including the i-1th semi-finished element deposited in radially outermost position, and
authorising the deposition of said i-th semi-finished element on the basis of a comparison between said current class and an expected class, said expected class being the i-th class in said ordered plurality of classes.

33. The system for checking according to claim 32, comprising a lighting system structured to illuminate at least partly said drum state.

34. A plant for building a tyre, the plant comprising:
a machine for building a tyre structured to deposit in sequence an ordered plurality of N semi-finished elements on a drum and
the system for checking according to claim 32.
